(19) United States
(12) Patent Application Publication
(10) Pub. No.: US 2026/0064392 A1
(43) Pub. Date: Mar. 5, 2026

(54) TECHNIQUES FOR HYBRID INSTRUMENTATION OF PROGRAM CODE

(71) Applicant: NVIDIA CORPORATION, Santa Clara, CA (US)

(72) Inventors: Sana DAMANI, Santa Clara, CA (US); Jaewook SHIN, San Jose, CA (US); Mark William STEPHENSON, Austin, TX (US); Aurelien CHARTIER, Kirkland, WA (US); Anis LADRAM, New York, NY (US)

(21) Appl. No.: 18/818,477

(22) Filed: Aug. 28, 2024

(51) Int. Cl. G06F 8/41

(52) U.S. Cl. CPC G06F 8/443

(57) ABSTRACT

One embodiment of a method for code instrumentation. The method includes in response to determining that a first portion of machine code was not instrumented during compilation of the first portion of machine code: performing one or more operations to instrument at least one part of the first portion of machine code, and executing the first portion of machine code.

### BACKGROUND

### Field of the Various Embodiments

The various embodiments relate generally to computer science and program code analysis and, more specifically, to techniques for hybrid instrumentation of program code.

### Description of the Related Art

Code instrumentation involves adding program code to an application in order to collect data about behaviors of the application during execution. The collected data allows a software developer to monitor and observe how the application behaves under different circumstances. Code instrumentation can be used to analyze applications for testing and debugging purposes, among other things.

One conventional approach for code instrumentation uses a compiler to perform the instrumentation. Compilers are programs that translate high-level source code written in a human-readable programming language into low-level machine code that can be executed by a computer, which is also referred to as “compiling” the source code. A compiler can instrument an application during the compilation process by identifying locations within source code of the application that correspond to behaviors of interest and then inserting instrumentation code at the identified locations.

One drawback of using a compiler for code instrumentation is that, oftentimes, the source code is not available for instrumentation by a compiler. For example, an application could utilize a programming library that includes a collection of pre-written code for performing common tasks. When the programming library is in the form of compiled machine code, as opposed to source code, a compiler cannot be used to instrument the programming library given that a compiler is only capable of processing source code.

Another conventional approach for code instrumentation, referred to as binary instrumentation, modifies an application that has already been compiled into machine code. For example, during execution of a given application, binary instrumentation can be used to identify portions of machine code for the application that correspond to behaviors of interest and insert, into the machine code, instrumentation code in the form of additional machine code to collect data about those behaviors.

One drawback of binary instrumentation is that, unlike a compiler, a runtime system that performs binary instrumentation does not have access to source code that can provide context for the instrumentation being performed. As a result, binary instrumentation may not be able to instrument code in as intelligent or efficient a manner as a compiler can instrument code. For example, whereas a compiler can analyze source code to identify which registers are live and need to be preserved while the instrumentation code executes, binary instrumentation may require-saving and restoring all of the registers, which is less efficient. Another drawback of binary instrumentation is that the execution of instrumentation code that has been inserted into machine code is typically much slower than the execution of instrumentation code that has been inserted into source code using a compiler. For example, instrumentation code that has been inserted into the machine code of a given application can sometimes take ten times longer to execute than instrumentation code that has been inserted into the source code of that application.

As the foregoing illustrates, what is needed in the art are more effective techniques for code instrumentation.

### SUMMARY

One embodiment of the present disclosure sets forth a computer-implemented method for code instrumentation. The method includes in response to determining that a first portion of machine code was not instrumented during compilation of the first portion of machine code: performing one or more operations to instrument at least one part of the first portion of machine code, and executing the first portion of machine code.

One technical advantage of the disclosed techniques relative to the prior art is that, with the disclosed techniques, a compiler, which can generate instrumented code that executes faster than instrumented code generated via binary instrumentation, is used to instrument portions of an application for which source code is available. A runtime system is then used to instrument other portions of the application for which source code is unavailable. With the disclosed techniques, the entire application can be instrumented more efficiently and intelligently than can be achieved with conventional approaches that rely on less intelligent binary instrumentation that can result in slower execution. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a more detailed illustration of the compiler of FIG. 1, according to various embodiments;

FIG. 5 is a more detailed illustration of the runtime system of FIG. 1, according to various embodiments;

FIG. 6 is a flow diagram of method steps for hybrid instrumentation of an application, according to various embodiments;

FIG. 7 is a flow diagram of method steps for instrumenting source code, according to various embodiments; and

FIG. 8 is a flow diagram of method steps for instrumenting, at runtime, portions of an application that were not instrumented by a compiler, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for hybrid instrumentation of program code. In some embodiments, a compiler instruments source code by inserting instrumentation code into one or more functions of the source code during compilation of the source code into machine code. The compiler also tags the function(s) into which instrumentation code has been inserted to indicate that those functions are instrumented. For example, to tag the function(s), the compiler could add, to metadata associated with the machine code, a respective flag indicating that each of the function(s) has been instrumented. As another example, to tag the function(s), the compiler could add a special instruction to the machine code of each of the instrumented function(s). A runtime system that executes machine code determines whether functions to be executed have been instrumented by the compiler. Returning to the examples in which flags are added to metadata associated with the machine code or special instructions are added, the runtime system could check whether functions to be executed have been flagged or include the special instruction, respectively. During execution of the machine code, the runtime system can instrument functions that have not been instrumented by the compiler prior to executing those functions.

The hybrid instrumentation techniques of the present disclosure have many real-world applications. For example, the hybrid instrumentation techniques can be used to instrument program code during analysis, testing, profiling, and/or debugging of the program code.

The above examples are not in any way intended to be limiting. As persons skilled in the art will appreciate, as a general matter, the hybrid instrumentation techniques described herein can be implemented in any application instrumentation of program code is required or useful.

### System Overview

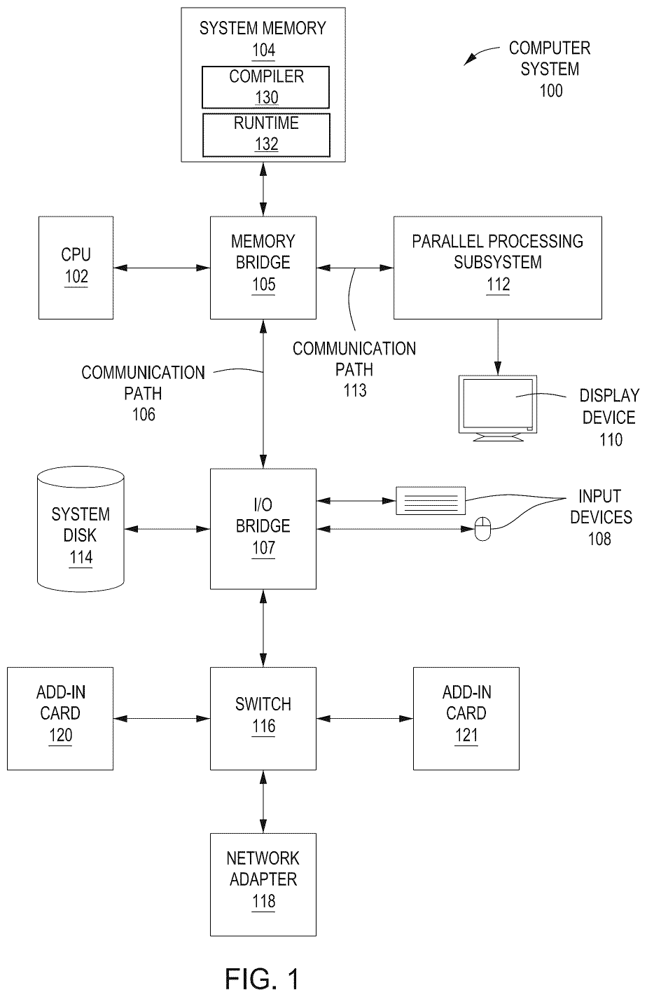

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 130. In one embodiment, switch 116 is configured to provide connections between I/O bridge 107 and other components of computer system 100, such as a network adapter 130 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

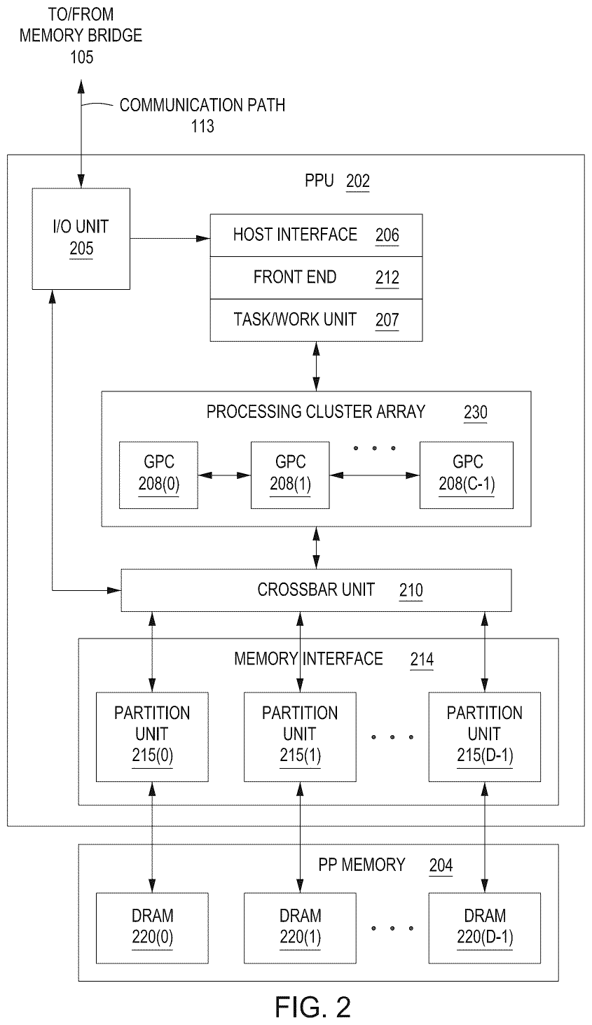

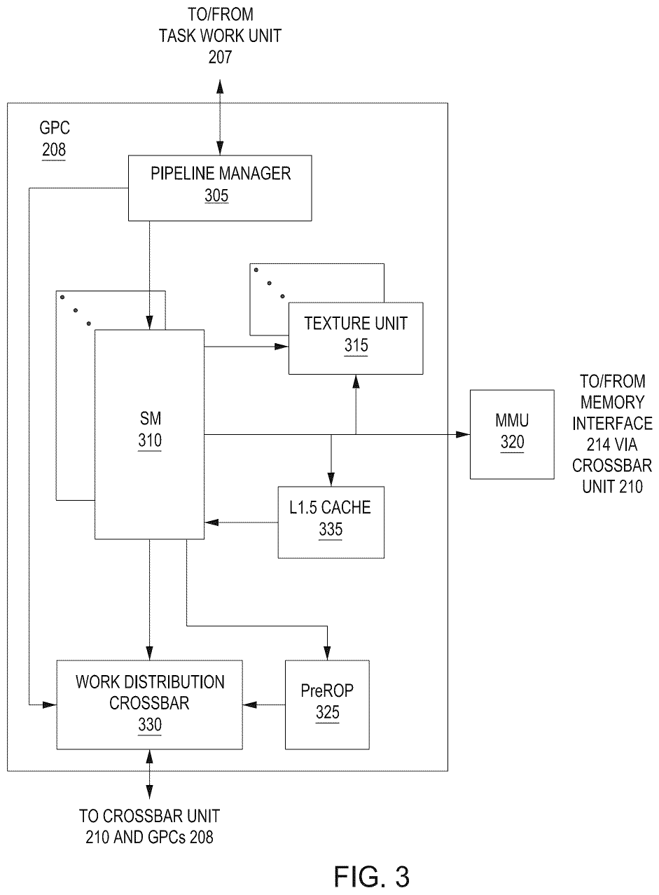

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

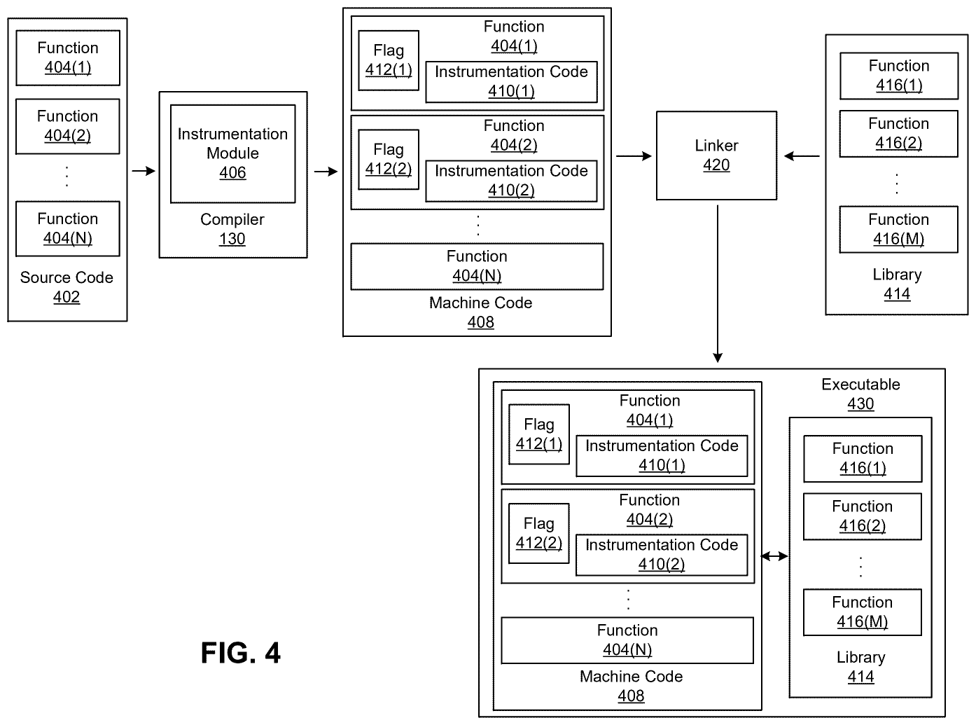

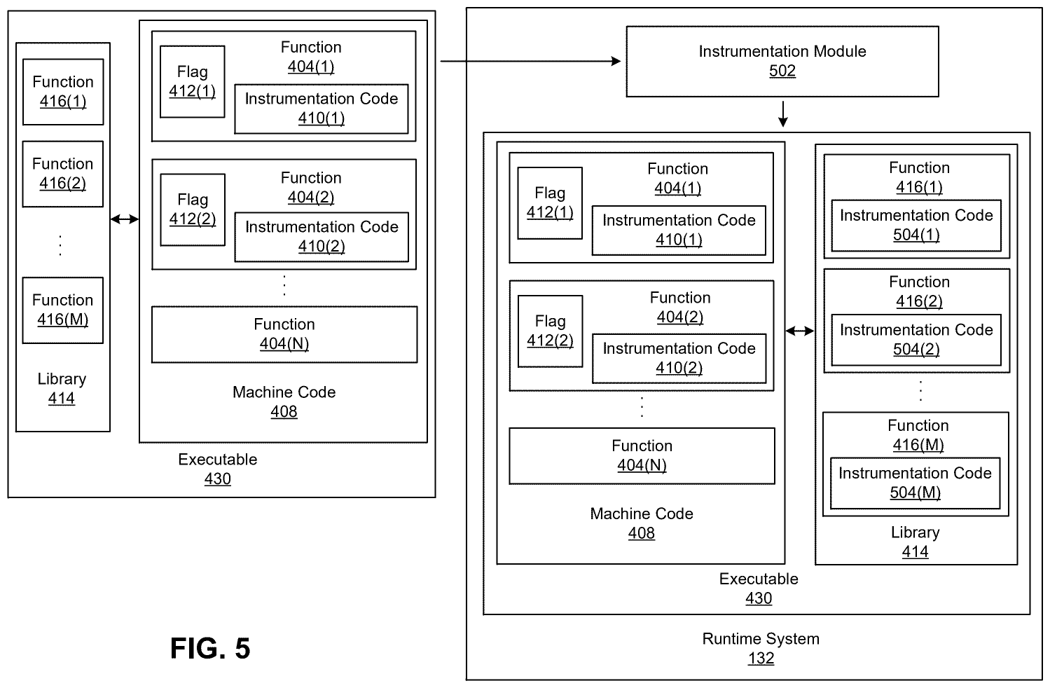

Illustratively, system memory 104 stores a compiler 130 and a runtime system 132. Compiler 130 is configured to translate source code in a human-readable programming language into machine code that can be executed by a computer. During the compilation process, compiler 130 can insert instrumentation code into one or more functions and/or other portions of an application for which source code is available, as discussed in greater detail below in conjunction with FIGS. 4 and 6-7. Runtime system 132 is configured to monitor and orchestrate the execution of machine code. During the execution of machine code, runtime system 132 identifies functions and/or other portions of the machine code that were not previously instrumented during compilation. Runtime system 132 can then instrument the identified functions and/or other portions of the machine code, as discussed in greater detail below in conjunction with FIGS. 5-6 and 8. Although compiler 130 and runtime system 132 are both shown as being stored and executed in computer system 100, in some embodiments, compiler 130 and runtime system 132 can be stored and executed in different computing systems. Although described herein primarily with respect to compiler 130 and runtime system 132 as reference examples, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 130 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 130.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Hybrid Instrumentation of Program Code

FIG. 4 is a more detailed illustration of compiler 130 of FIG. 1, according to various embodiments. As shown, compiler 130 includes an instrumentation module 406. In operation, compiler 130 receives as input source code 402 for an application in a human-readable programming language, and compiler 130 translates source code 402 into low-level machine code 408 that can be executed by a computer. Source code may be unavailable for other portion(s) of the application, in which case compiler 130 cannot compile those portion(s) of the application. For example, the application could utilize one or more pre-compiled libraries for which source code is unavailable.

During the compilation process, instrumentation module 146 of compiler 130 instruments source code 402 by inserting instrumentation code into one or more functions 404(1)-(N) (referred to herein as collectively as functions 404 and individually as a function 404) and/or other portions (e.g., modules) of source code 402. In some embodiments, instrumentation module 406 can insert any technically feasible instrumentation code at any suitable location or locations during one pass of the compilation process. The entire compilation process can include multiple passes that each performs one or operations to transform or optimize the program. Compiler 130 sequentially applies the passes, where the output of one pass is the input to the next pass. The input into and output of one or more of passes can be an intermediate representation (IR) that reflects the semantics of the application received at step 702 but is efficient for compiler passes to operate on, and one of the passes can include instrumenting functions and/or other portions of the source code. In some other embodiments, instrumentation module 406 can perform instrumentation in any technically feasible manner. For example, in some embodiments, instrumentation module 406 can insert instrumentation code into source code, and then compiler 130 then can compile the source code with the inserted instrumentation code.

As a specific example, to check for illegal memory accesses, instrumentation module 406 could identify locations in the application corresponding to memory accesses and then insert, at the identified locations, instrumentation code that calls another function to check whether the memory addresses being accessed are illegal memory accesses. In addition, the instrumentation code could cause an error notification to be displayed via a display device when an illegal memory access occurs. More generally, instrumentation module 406 can insert instrumentation code that checks for issues before instructions that may be problematic, that profiles portions of code to check how many times those portions execute, and/or the like. In addition, the instrumentation performed by instrumentation module 406 can preserve the semantics of source code 402 so that the application otherwise executes normally.

Compiler 130 compiles the source code 402 into machine code 408 that is instrumented. Machine code 408 can be low-level code in an assembly language that is executable by a computer. In some embodiments, machine code 408 can be in binary form. In addition, compiler 130 tags function(s) 404 and/or other portions of code into which instrumentation code was inserted to indicate that those function(s) 404 and/or other portions of code have been instrumented. In some embodiments, to tag a function 404 or other portion of code as being instrumented, compiler 130 can add, to metadata associated with machine code 408, a flag indicating that the function 404 or other portion of code has been instrumented. In such cases, the metadata associated with machine code 408 can include metadata that is specific to the function 404 and/or other portion of code, and the flag can be added to metadata that is specific to the function 404 and/or other portion of code. In some embodiments, the metadata associated with machine code 408 can also include other information, such as information about how an application associated with machine code 408 was compiled, other properties of such an application, etc. For example, an Executable and Linkable Format (ELF) flag can be added to the metadata associated with machine code 408 in some embodiments. In some other embodiments, to tag a function 404 or other portion of code as being instrumented, compiler 130 can add a special instruction to machine code 408 associated with that function 404 or other portion of code. For example, the special instruction could be added to the beginning of machine code 408 associated with a function 404 or other portion of code. In such cases, the special instruction can be an instruction that no compiler would otherwise add, except to indicate that a function 404 or other portion of code has been instrumented by compiler 130. For example, in some embodiments, the special instruction can be a No Operation (NOP) instruction.

In some embodiments, a tag (e.g., a flag in metadata or instruction) can also indicate how a function 404 or other portion of code is instrumented. For example, a function 404 or other portion of code could be tagged as being instrumented to check for one type of issue, and runtime system 132 could perform additional instrumentation of the function 404 or other portion of code, by injecting instrumentation code into machine code 408, to check for other types of issues. In some embodiments, a user can direct compiler 130 to only instrument specific function(s) in source code.

Illustratively, instrumentation module 406 has instrumented functions 404(1) and 404(2) with instrumentation code 410(1) and 410(2), respectively, and compiler 130 has added flags 412(1) and 412(2) in metadata (not shown) associated with machine code 408 at the beginning of functions 404(1) and 404(2), respectively, in machine code 408 to indicate that functions 404(1) and 404(2) have been instrumented. By contrast, instrumentation module 406 did not instrument function 404(N), and no flag is added to the metadata associated with machine code 408 to indicate that function 404(N) has been instrumented. For example, a user could have specified that function 404(N) should not be instrumented. In addition, a linker 420 has linked machine code 408 to a pre-compiled programming library 414 that includes a number of functions 416(1)-(M) (referred to herein collectively as functions 416 and individually as a function 416) to generate an executable 430 that includes compiled machine code 408 linked to pre-compiled programming library 414 that also includes machine code. For example, source code 402 could specify that the application utilizes one or more of the functions 416 in programming library 414. Any technically feasible linker 420, including well-known linkers, can be used in some embodiments to link machine code 408 to programming library 414. Notably, programming library 414 has been pre-compiled into machine code and is, therefore, not compiled or instrumented by compiler 130.

FIG. 5 is a more detailed illustration of runtime system 132 of FIG. 1, according to various embodiments. As shown, runtime system 132 includes an instrumentation module 502. In operation, runtime system 132 receives executable 430 that includes machine code 408 and programming library 414 as input, and runtime system 132 monitors and orchestrates the execution of executable 430, including machine code 408 and functions 416 in programming library 414. Executable 430 can be executed on any suitable processor or processors. For example, in some embodiments, executable 430 can be executed on CPU 102 and/or parallel processing subsystem 112, such as a GPU. In some embodiments, instrumentation module 502 is a runtime library that executes along with the application associated with executable 430. In such cases, the runtime library can perform any suitable operations, such as maintaining runtime metadata, intercepting application programming interface (API) calls as the application is executing, capturing the state of the application, and/or capturing memory allocations, as well as instrumenting machine code, as appropriate.

During execution of executable 430, instrumentation module 502 identifies functions and/or other portions of executable 430 that are not tagged as being instrumented by compiler 130. For example, functions 416 from pre-compiled programming library 414, for which source code was not available for compilation by compiler 130, are not tagged as being instrumented. In some embodiments, instrumentation module 502 can instrument functions and/or other portions of machine code for an application that were not instrumented by compiler 130, as appropriate. In some other embodiments, instrumentation module 502 can instrument functions and/or other portions of machine code for an application that were instrumented by compiler 130 to check for certain issues, but with additional instrumentation code that checks for other issues. For example, compiler 130 could perform instrumentation to check for memory safety violations, while runtime system 132 could perform instrumentation to check for other optional features that relate to performance rather than correctness, such as sanity checks that data prefetches do not escape allocated memory. In some other embodiments, runtime system 132 can be configured (e.g., via command line input) to not perform instrumentation, such as if only compiler instrumentation is desired, or to not instrument specific functions. In some embodiments, instrumentation module 502 can perform any technically feasible instrumentation, such as inserting instrumentation code that checks for issues before instructions in machine code that may be problematic (e.g., memory accesses), instrumentation code that performs profiling, etc. while preserving the semantics of machine code so that the application otherwise executes normally. In some embodiments, instrumentation module 502 can perform similar and/or different instrumentation than instrumentation module 406, described above in conjunction with FIG. 4, except instrumentation module 502 inserts instrumentation code into machine code rather than source code. When the machine code is in the form of binary that is executable by a computer, instrumentation module 502 can instrument the machine code at the binary level, i.e., perform binary instrumentation.

In some embodiments in which flags are added to metadata associated with machine code to indicate functions and/or other portions thereof that have been instrumented, runtime system 132 can check, prior to executing an application associated with the machine code, which functions and/or other portions of the machine code have been flagged in the metadata. Then, runtime system 132 can instrument functions and/or other portions of the machine code that have not been instrumented by compiler 130. Illustratively, functions 416 in the programming library 414 are not flagged as having been instrumented by compiler 130. When instrumentation module 502 does not identify a flag associated with functions 416, instrumentation module 502 instruments functions 416 with instrumentation code, shown as instrumentation code 504(1)-(M) (referred to herein collectively as instrumentation code 504 and individually as instrumentation code 504) for functions 416(1)-(M), respectively. Then, runtime system 132 can execute functions 416 along with the associated instrumentation code 504. In some embodiments in which special instructions (e.g., NOP instructions) rather than metadata flags are used to indicate that functions and/or other portions of machine code have been instrumented, runtime system 132 can check, during execution of machine code, whether functions and/or other portions of the machine code to be executed include the special instruction and instrument functions and/or other portions that do include the special instruction. In some embodiments, in addition to instrumenting the functions and/or other portions of machine code that have not been instrumented by compiler 130, runtime system 132 can output (e.g., via a display device) warnings, which can be disabled if desired, to indicate that those functions and/or other portions of machine code will execute slower and/or with reduced instrumentation coverage due to the instrumentation by runtime system 132.

In some embodiments, instrumentation module 502 does not instrument functions and/or other portions of machine code 408 that are tagged as instrumented by compiler 130. Illustratively, instrumentation module 502 does not instrument functions 404(1)-(2) because flags 412(1)-(2) in metadata associated with machine code 408 indicate that functions 404(1)-(2), respectively, were instrumented by compiler 130. Advantageously, by not instrumenting function(s) and/or other portions of machine code that were instrumented by compiler 130, runtime system 132 can avoid instrumenting those function(s) and/or other portions at runtime, which can be less intelligent and/or result in slower execution than instrumenting the function(s) and/or other portions by compiler 130. In some embodiments, a user can direct runtime system 130 to only instrument specific function(s) so that other function(s) that are not instrumented can run at full speed. Illustratively, function 404(N) has not been instrumented at all because a user has requested runtime system 130 to not instrument function 404(N).

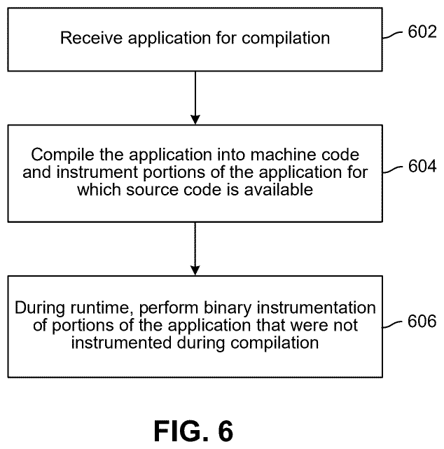

FIG. 6 is a flow diagram of method steps for hybrid instrumentation of program code, according to various embodiments. Although the method steps are described in conjunction with FIGS. 1-5, persons skilled in the art will understand that any system configured to perform the method steps, in any order, falls within the scope of the present disclosure.

As shown, a method 600 begins at step 602, where compiler 130 receives an application for compilation. The application can include source code for compilation in any technically feasible programming language, and the application can also utilize one or more programming libraries and/or include other code that was previously compiled into machine code.

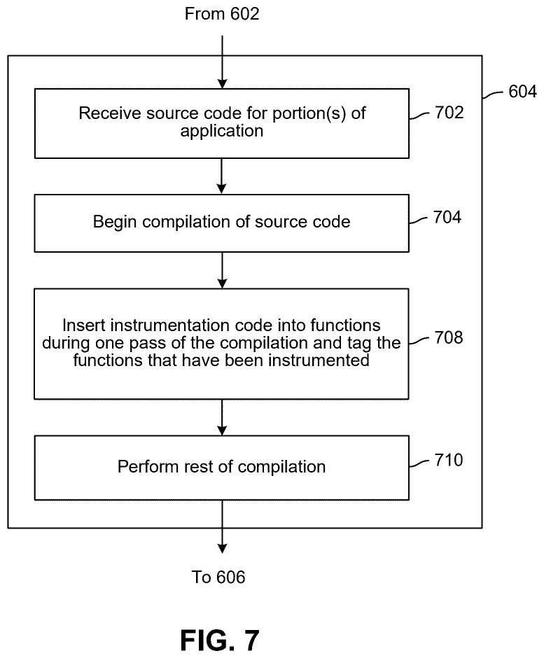

At step 604, compiler 130 compiles the application into machine code and instruments portions of the application for which source code is available. In some embodiments, compiler 130 can instrument the portions of the application for which source code is available by (1) inserting instrumentation code into functions during one pass of the compilation, and (2) tagging the functions that have been instrumented, as discussed in greater detail below in conjunction with FIG. 7. In some other embodiments, compiler 130 can instrument the portions of the application for which source code is available in any technically feasible manner. For example, in some embodiments, compiler 130 can insert instrumentation code into the source code and then compile the source code with the inserted instrumentation code.

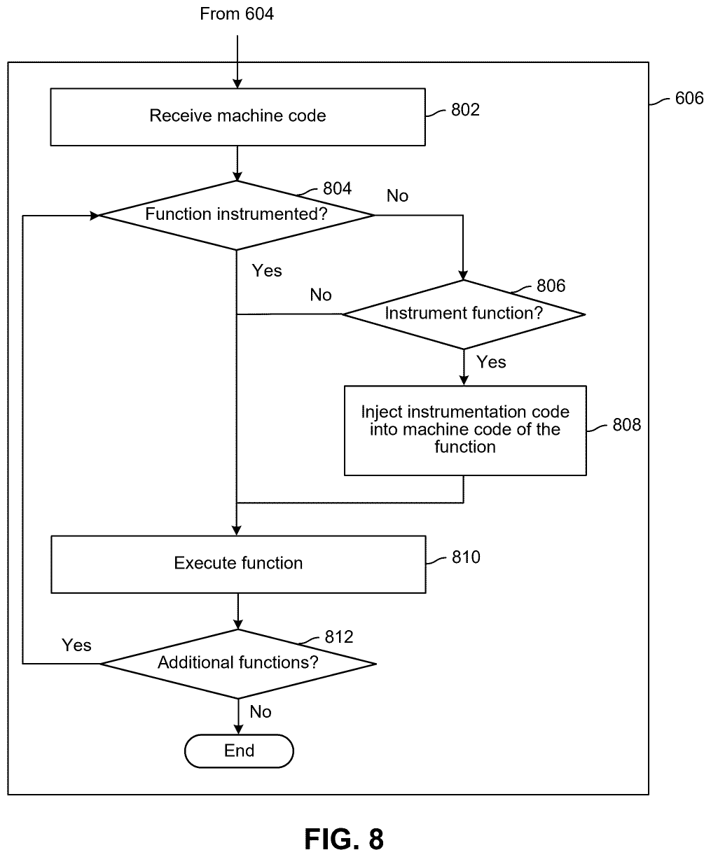

At step 606, during runtime, runtime system 132 performs binary instrumentation of portions of the application that were not instrumented during compilation. In some embodiments, prior to executing a function or other portion of the machine code, runtime system 132 checks whether the function or other portion of the machine code was instrumented during compilation, such as by checking if the function or other portion is tagged as having been previously instrumented. For the functions and/or other portions of machine code that were not instrumented during complication, runtime system 132 performs binary instrumentation of those functions and/or other portions, as discussed in greater detail below in conjunction with FIG. 8.

FIG. 7 is a flow diagram of method steps for instrumenting source code at step 604 of method 600, according to various embodiments. Although the method steps are described in conjunction with FIGS. 1-5, persons skilled in the art will understand that any system configured to perform the method steps, in any order, falls within the scope of the present disclosure.

As shown, at step 702, compiler 130 receives the source code for one or more portions of an application. Source code for some portions of the application can be available, while source code for other portions may not be available. For example, the application could utilize a programming library that has already been compiled into machine code, and source code for the programming library may not be available.

At step 704, compiler 130 begins compiling the source code. In some embodiments, the compilation process can include multiple passes, each of which includes one or operations to transform or optimize a program. Compiler 130 sequentially applies the passes, where the output of one pass is the input to the next pass. The input into and output of one or more of the passes can be an IR that reflects the semantics of the application received at step 702, but that is efficient for compiler passes to operate on. An IR is the data structure or code used internally by compiler 130 to represent the source code.

At step 706, compiler 130 inserts instrumentation code into functions during one pass of the compilation and tags the functions that have been instrumented. As described, the compilation process can include multiple passes. One such pass can transform the IR that is input into the pass by adding instrumentation code to the IR. Any suitable instrumentation code can be added, such as instrumentation code for memory checking, profiling, etc. depending on the objective of instrumentation and whether a user has requested for certain functions to be instrumented. Further, in some embodiments, a user may request that only specific functions be instrumented. Although step 706 is described with respect to functions, in some embodiments, compiler 130 can insert instrumentation code into any suitable portion(s) of the IR that is input into the instrumentation pass of the compilation process.

In addition, compiler 130 can tag the functions as being instrumented in any technically feasible manner in some embodiments. For example, in some embodiments, compiler 130 can add, to metadata associated with the compiled code or a portion thereof, a flag (e.g., an ELF flag) indicating that a function has been instrumented. In such cases, the metadata associated with the compiled code can include metadata that is specific to each function, and flags can be added to metadata that is specific to the functions that have been instrumented. As another example, in some embodiments, compiler 130 can add a special instruction (e.g., a NOP instruction) that no compiler would otherwise add, in order to indicate that a function has been instrumented by compiler 130. In some embodiments, a tag can also indicate how a function is instrumented. For example, a function could be tagged as being instrumented to check for one type of issue, and runtime system 132 could perform additional instrumentation of that function to check for other types of issues.

At step 708, compiler 130 performs the rest of compilation. In some embodiments, the rest of compilation can include one or more additional passes, described above. In some embodiments, the compiled source code can also be linked to other machine code, such as one or more pre-compiled programming libraries, as described above in conjunction with FIG. 4.

FIG. 8 is a flow diagram of method steps for instrumenting, at step 606 of method 600, portions of an application that were not instrumented by a compiler, according to various embodiments. Although the method steps are described in conjunction with FIGS. 1-5, persons skilled in the art will understand that any system configured to perform the method steps, in any order, falls within the scope of the present disclosure.

As shown, at step 802, runtime system 132 receives machine code. The machine code is compiled source code that includes machine language instructions that can be executed by one or more processors, such as CPU 102 or parallel processing subsystem 112. In some embodiments, the machine code can include code that is compiled from source code according to the steps described above in conjunction with FIG. 7, one or more pre-compiled programming libraries, etc.

At step 804, runtime system 132 determines whether a function in the machine code that is to be executed has been instrumented. Although FIG. 8 is described with respect to functions as a reference example, in some embodiments, a runtime system (e.g., runtime system 132) can process any portions of machine code (e.g., modules) according to techniques described herein. In some embodiments, runtime system 132 can determine whether the function (or other portion of machine code) has been instrumented based on if the function is tagged as being instrumented or not. For example, when metadata associated with the machine code includes flags indicating functions that have been instrumented, runtime system 132 could determine, prior to executing the application associated with the machine code, which functions are flagged in the metadata as being instrumented. As another example, in some embodiments, when the machine code includes special instructions to indicate functions that have been instrumented by compiler 130, runtime system 132 could determine whether the machine code associated with the function includes a special instruction.

If runtime system 132 determines the function is not instrumented, then at step 806, runtime system 132 determines whether to instrument the function. Runtime system can determine whether to instrument the function in any technically feasible manner, depending on the objective of instrumentation and whether a user has requested for the function to be instrumented. For example, in some embodiments, runtime system 132 can insert instrumentation code for memory checking, profiling, etc. before instructions in the machine code that may be problematic. As another example, in some embodiments, a user may request that only specific functions be instrumented.

If runtime system 132 determines to instrument the function, then at step 808, runtime system 132 injects instrumentation code into machine code of the function. The instrumentation code includes machine language instructions, which runtime system 132 inserts into the machine code of the function. The machine code can be low-level code in an assembly language that is executable by a computer. When the machine code is in the form of binary that is executable by a computer, the machine code can be instrumented at the binary level, i.e., binary instrumentation is performed. In some embodiments, in addition to injecting instrumentation code into machine code of the function, runtime system 132 can output (e.g., via a display device) a warning, which can be disabled if desired, to indicate that the function will execute slower and/or with reduced instrumentation coverage due to the instrumentation by runtime system 132.

After injecting the instrumentation code into the machine code of the function, or if runtime system 132 determines at step 804 that the function was instrumented by compiler 130 or at step 806 that the function does not need to be instrumented, method 800 continues to step 810, where runtime system 132 executes the function. Although shown with respect to runtime system 132 executing the function without instrumenting the function if the function was instrumented by compiler 130, in some embodiments, runtime system 132 can also instrument functions that were previously instrumented by compiler 130. For example, a particular function could be tagged as being instrumented to check for one type of issue, and runtime system 132 could instrument the particular function to check for other types of issues.

At step 812, if there are additional functions in the machine code, then method 800 returns to step 804, where runtime system 132 determines whether another function to be executed has been instrumented. On the other hand, if there are no additional functions, then method 800 ends. Although method 800 is shown as ending for simplicity, it should be understood that runtime system 132 can continue executing remaining code in the machine code, if any.

In sum, techniques are disclosed for hybrid instrumentation of program code. In some embodiments, a compiler instruments source code by inserting instrumentation code into one or more functions of the source code during compilation of the source code into machine code. The compiler also tags the function(s) into which instrumentation code has been inserted to indicate that those functions are instrumented. For example, to tag the function(s), the compiler could add, to metadata associated with the machine code, a respective flag indicating that each of the function(s) has been instrumented. As another example, to tag the function(s), the compiler could add a special instruction to the machine code of each of the instrumented function(s). A runtime system that executes machine code determines whether functions to be executed have been instrumented by the compiler. Returning to the examples in which flags are added to metadata associated with the machine code or special instructions are added, the runtime system could check whether functions to be executed have been flagged or include the special instruction, respectively. During execution of the machine code, the runtime system can instrument functions that have not been instrumented by the compiler prior to executing those functions.

One technical advantage of the disclosed techniques relative to the prior art is that, with the disclosed techniques, a compiler, which can generate instrumented code that executes faster than instrumented code generated via binary instrumentation, is used to instrument portions of an application for which source code is available. A runtime system is then used to instrument other portions of the application for which source code is unavailable. With the disclosed techniques, the entire application can be instrumented more efficiently and intelligently than can be achieved with conventional approaches that rely on less intelligent binary instrumentation that can result in slower execution. These technical advantages provide one or more technological improvements over prior art approaches.

1. In some embodiments, a computer-implemented method for code instrumentation comprises in response to determining that a first portion of machine code was not instrumented during compilation of the first portion of machine code performing one or more operations to instrument at least one part of the first portion of machine code, and executing the first portion of machine code.

2. The computer-implemented method of clause 1, further comprising in response to determining that a second portion of machine code was instrumented during compilation of the second portion of machine code, executing the second portion of machine code without performing any operations to instrument the second portion of machine code.

3. The computer-implemented method of clauses 1 or 2, further comprising determining that the second portion of machine code was instrumented during compilation of the second portion of machine code based on a tag associated with the second portion of machine code.

4. The computer-implemented method of any of clauses 1-3, further comprising determining that the second portion of machine code was instrumented during compilation of the second portion of machine code based on a flag associated with the second portion of machine code in metadata associated with the machine code.

5. The computer-implemented method of any of clauses 1-4, further comprising determining that the second portion of machine code was instrumented during compilation of the second portion of machine code based on an instruction included in the second portion of machine code.

6. The computer-implemented method of any of clauses 1-5, further comprising in response to determining that a second portion of machine code was instrumented using first instrumentation code during compilation of the second portion of machine code performing one or more operations to instrument at least one part of the second portion of machine code using second instrumentation code, and executing the second portion of machine code.

7. The computer-implemented method of any of clauses 1-6, further comprising determining that the first portion of machine code was not instrumented during compilation of the first portion of machine code based on metadata associated with the machine code.

8. The computer-implemented method of any of clauses 1-7, further comprising performing one or more operations to instrument source code during compilation of the source code into a second portion of machine code, and performing one or more operations to tag the second portion of machine code as being instrumented.

9. The computer-implemented method of any of clauses 1-8, wherein the first portion of machine code comprises a function.

10. The computer-implemented method of any of clauses 1-9, wherein performing one or more operations to instrument the first portion of machine code comprises determining one or more instructions of interest in the first portion of machine code, and injecting, into the first portion of machine code before the one or more instructions of interest, additional machine code.

11. In some embodiments, one or more non-transitory computer-readable media store instructions that, when executed by at least one processor, cause the at least one processor to perform steps comprising in response to determining that a first portion of machine code was not instrumented during compilation of the first portion of machine code performing one or more operations to instrument at least one part of the first portion of machine code, and executing the first portion of machine code.

12. The one or more non-transitory computer-readable media of clause 11, wherein the instructions, when executed by the at least one processor, further cause the at least one processor to perform the step of in response to determining that a second portion of machine code was instrumented during compilation of the second portion of machine code, executing the second portion of machine code without performing any operations to instrument the second portion of machine code.

13. The one or more non-transitory computer-readable media of clauses 11 or 12, wherein the instructions, when executed by the at least one processor, further cause the at least one processor to perform the step of determining that the second portion of machine code was instrumented during compilation of the second portion of machine code based on a flag associated with the second portion of machine code in metadata associated with the machine code.

14. The one or more non-transitory computer-readable media of any of clauses 11-13, wherein the flag comprises an Executable and Linkable Format (ELF) flag.

15. The one or more non-transitory computer-readable media of any of clauses 11-14, wherein the instructions, when executed by the at least one processor, further cause the at least one processor to perform the step of determining that the second portion of machine code was instrumented during compilation of the second portion of machine code based on an instruction included in the second portion of machine code.

16. The one or more non-transitory computer-readable media of any of clauses 11-15, wherein the instruction comprises a No Operation (NOP) instruction.

17. The one or more non-transitory computer-readable media of any of clauses 11-16, wherein the instructions, when executed by the at least one processor, further cause the at least one processor to perform the steps of in response to determining that a second portion of machine code was instrumented using first instrumentation code during compilation of the second portion of machine code performing one or more operations to instrument at least one part of the second portion of machine code using second instrumentation code, and executing the second portion of machine code.

18. The one or more non-transitory computer-readable media of any of clauses 11-17, wherein the instructions, when executed by the at least one processor, further cause the at least one processor to perform the steps of performing one or more operations to instrument source code during compilation of the source code into a second portion of machine code, and performing one or more operations to tag the second portion of machine code as being instrumented.

19. The one or more non-transitory computer-readable media of any of clauses 11-18, wherein the first portion of machine code comprises a function included in a programming library.

20. In some embodiments, a system comprises one or more memories storing instructions, and one or more processors that are coupled to the one or more memories and, when executing the instructions, are configured to perform the steps of in response to determining that a first portion of machine code was not instrumented during compilation of the first portion of machine code perform one or more operations to instrument at least one part of the first portion of machine code, and execute the first portion of machine code.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for code instrumentation, the method comprising:
in response to determining that a first portion of machine code was not instrumented during compilation of the first portion of machine code:
performing one or more operations to instrument at least one part of the first portion of machine code, and
executing the first portion of machine code.

2. The computer-implemented method of claim 1, further comprising in response to determining that a second portion of machine code was instrumented during compilation of the second portion of machine code, executing the second portion of machine code without performing any operations to instrument the second portion of machine code.

3. The computer-implemented method of claim 2, further comprising determining that the second portion of machine code was instrumented during compilation of the second portion of machine code based on a tag associated with the second portion of machine code.

4. The computer-implemented method of claim 2, further comprising determining that the second portion of machine code was instrumented during compilation of the second portion of machine code based on a flag associated with the second portion of machine code in metadata associated with the machine code.

5. The computer-implemented method of claim 2, further comprising determining that the second portion of machine code was instrumented during compilation of the second portion of machine code based on an instruction included in the second portion of machine code.

6. The computer-implemented method of claim 1, further comprising in response to determining that a second portion of machine code was instrumented using first instrumentation code during compilation of the second portion of machine code:
performing one or more operations to instrument at least one part of the second portion of machine code using second instrumentation code; and
executing the second portion of machine code.

7. The computer-implemented method of claim 1, further comprising determining that the first portion of machine code was not instrumented during compilation of the first portion of machine code based on metadata associated with the machine code.

8. The computer-implemented method of claim 1, further comprising:
performing one or more operations to instrument source code during compilation of the source code into a second portion of machine code; and
performing one or more operations to tag the second portion of machine code as being instrumented.

9. The computer-implemented method of claim 1, wherein the first portion of machine code comprises a function.

10. The computer-implemented method of claim 1, wherein performing one or more operations to instrument the first portion of machine code comprises:
determining one or more instructions of interest in the first portion of machine code; and
injecting, into the first portion of machine code before the one or more instructions of interest, additional machine code.

11. One or more non-transitory computer-readable media storing instructions that, when executed by at least one processor, cause the at least one processor to perform steps comprising:
in response to determining that a first portion of machine code was not instrumented during compilation of the first portion of machine code:
performing one or more operations to instrument at least one part of the first portion of machine code, and
executing the first portion of machine code.

12. The one or more non-transitory computer-readable media of claim 11, wherein the instructions, when executed by the at least one processor, further cause the at least one processor to perform the step of in response to determining that a second portion of machine code was instrumented during compilation of the second portion of machine code, executing the second portion of machine code without performing any operations to instrument the second portion of machine code.

13. The one or more non-transitory computer-readable media of claim 12, wherein the instructions, when executed by the at least one processor, further cause the at least one processor to perform the step of determining that the second portion of machine code was instrumented during compilation of the second portion of machine code based on a flag associated with the second portion of machine code in metadata associated with the machine code.

14. The one or more non-transitory computer-readable media of claim 13, wherein the flag comprises an Executable and Linkable Format (ELF) flag.

15. The one or more non-transitory computer-readable media of claim 12, wherein the instructions, when executed by the at least one processor, further cause the at least one processor to perform the step of determining that the second portion of machine code was instrumented during compilation of the second portion of machine code based on an instruction included in the second portion of machine code.

16. The one or more non-transitory computer-readable media of claim 15, wherein the instruction comprises a No Operation (NOP) instruction.

17. The one or more non-transitory computer-readable media of claim 11, wherein the instructions, when executed by the at least one processor, further cause the at least one processor to perform the steps of in response to determining that a second portion of machine code was instrumented using first instrumentation code during compilation of the second portion of machine code:
performing one or more operations to instrument at least one part of the second portion of machine code using second instrumentation code; and
executing the second portion of machine code.

18. The one or more non-transitory computer-readable media of claim 11, wherein the instructions, when executed by the at least one processor, further cause the at least one processor to perform the steps of:
performing one or more operations to instrument source code during compilation of the source code into a second portion of machine code; and
performing one or more operations to tag the second portion of machine code as being instrumented.

19. The one or more non-transitory computer-readable media of claim 11, wherein the first portion of machine code comprises a function included in a programming library.

20. A system, comprising:
one or more memories storing instructions; and
one or more processors that are coupled to the one or more memories and, when executing the instructions, are configured to perform the steps of:
in response to determining that a first portion of machine code was not instrumented during compilation of the first portion of machine code:
perform one or more operations to instrument at least one part of the first portion of machine code, and
execute the first portion of machine code.
